(19) United States
(12) Patent Application Publication
(10) Pub. No.: US 2016/0169657 A1
(43) Pub. Date: Jun. 16, 2016

(54) SYSTEM FOR MEASURING THE THICKNESS OF A LINER LAYER OF A TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Thomas LEDOUX, Clermont-Ferrand (FR); Denis MARTIN, Clermont-Ferrand (FR); Patrick MENEROUD, Meylan Cedex (FR)

(21) Appl. No.: 14/907,174

(22) PCT Filed: Jul. 25, 2014
(86) PCT No.: PCT/EP2014/066015

§ 371 Date: Jan. 22, 2016

(30) Foreign Application Priority Data
Jul. 26, 2013 (FR) 1357409

(51) Int. Cl. G01B 7/26; G01M 17/02

(52) U.S. Cl. CPC G01B 7/26; G01M 17/02

(57) ABSTRACT

A system is provided for measuring a thickness of a rubber layer of a tire. The layer includes a joined face, which is joined to an adjacent metallic reinforcement, and a free face in contact with air. The system includes a casing with an application face for contacting the free face, and a sensor positioned in the casing and structured to measure a distance d between the joined face and the free face. The sensor includes a source coil element, which is a source of an alternating magnetic field, and a sensitive coil element, which is an element sensitive to a variation in a magnetic flux density in a vicinity of the source coil element. A frequency and an excitation power of the source coil element are such that the magnetic flux density between the adjacent metallic reinforcement and the source coil element increases as the distance d decreases.

### FIELD OF THE INVENTION

The present invention relates to a system for measuring the thickness of a layer of rubber, and more particularly to the measurement of the thickness of remaining rubber on a tread of a tire.

### PRIOR ART

In a known way, the tread of a pneumatic tire, or more simply a tire, regardless of whether it is to be fitted on a passenger vehicle, a heavy transport vehicle, a civil to engineering vehicle, or other vehicle, is provided with a tread pattern comprising, notably, pattern elements or elementary blocks delimited by various main, longitudinal, transverse or even oblique grooves, the elementary blocks also possibly comprising various finer slits or sipes. The grooves form channels intended to discharge the water during running on wet ground, and define the leading edges of the pattern elements.

When a tire is new, the depth of the tread is at a maximum. This initial depth may vary according to the type of tire in question, as well as the use for which it is intended; by way of example, “winter” tires generally have a pattern depth greater than that of “summer” tires. When the tire becomes worn, the depth of the elementary blocks of the pattern decreases and the stiffness of these elementary blocks increases. The increase in the stiffness of the elementary pattern blocks causes a reduction in some performance characteristics of the tire, such as the grip on wet ground. The water discharge capacity also decreases markedly when the depth of the channels in the patterns decreases.

It is therefore desirable to be able to monitor the development of the wear of the tread of a tire.

This monitoring is usually carried out by visual observation of the tread by the user or a mechanic, with or without actual measurement with a depth gauge. However, this observation is not very easy to carry out, notably on rear tires which are harder to access, and furthermore it is not very precise.

Numerous proposals have been made to automate the measurement of the depth of tire tread patterns. Such devices can be placed on the roadway on which vehicles run. These devices usually operate by two techniques, either based on optical systems with cameras or lasers, or based on eddy currents.

The systems based on optical systems are costly, have to be embedded in the roadway, and require regular maintenance. Moreover, the measurements are subject to interference due to soiling and the presence or spraying of water, mud, snow, etc.

Documents U.S. Pat. No. 7,578,180 B2 and WO 2008/059283 propose systems for measuring the thickness of the tread of a tire, comprising sensors sensitive to the eddy currents generated by an excitation magnetic field in the crown reinforcement of the tire. These systems are placed on a roadway.

However, these measurement systems are not entirely satisfactory because they are sensitive to the electric conductivity of the crown of the tires which itself varies from one tire to another and also according to the degree of tire wear. The measurements are found to be insufficiently precise and insufficiently sensitive.

### BRIEF DESCRIPTION OF THE INVENTION

One subject of the invention is a system for measuring the thickness of a layer of rubber material of a tire, the layer comprising a face joined to an adjacent reinforcement made with at least one material having a magnetic permeability greater than the magnetic permeability of air, and a free face in contact with the air, and the system comprising a casing with an application face intended to be in contact with the free face of the layer and a sensor placed in the casing and capable of measuring the distance d between the joined face and the free face of the layer of rubber material. This system is characterized in that, with the sensor comprising a source of alternating magnetic field and an element sensitive to the variation in the magnetic flux density in the vicinity of the said source coil, the source is a coil and the sensitive element is a second coil, and in that the frequency and the excitation power of the source coil are such that the magnetic flux density between the adjacent reinforcement and the source coil increases as the distance d decreases.

According to one subject of the invention, the sensor of the measurement system has the advantage of operating in reluctance mode, and therefore with a lower coil excitation frequency for a given power than in the case of a similar sensor operating in a mode sensitive to eddy currents. It should be noted that in the case of the usual tire crown reinforcements, made up of metallic reinforcers embedded in a rubber material with barely any conductivity, no eddy currents or only very weak eddy currents are detected under these operating conditions.

Measurement in reluctance mode also makes use of the magnetic permeability of the adjacent reinforcement, and has been found to provide high measurement sensitivity to any variation in the distance d.

According to one preferred embodiment, the coil of the sensitive element is positioned between the source coil and the application face of the casing.

In this embodiment, the amplitude of the voltage at the terminals of the coil of the sensitive element increases as the distance d decreases.

In another embodiment, the source coil is positioned between the coil of the sensitive element and the application face.

In this embodiment, the amplitude of the voltage at the terminals of the coil of the sensitive element decreases as the distance d decreases.

The coils of the sensitive element and source may also be positioned without overlap so they are adjacent and substantially the same distance from the application face of the casing.

In this embodiment, the amplitude of the voltage at the terminals of the coil of the sensitive element decreases also when the distance d decreases.

Advantageously, the source coil and coil of the sensitive element may surround, or be surrounded by, a material with high electrical resistivity and high magnetic permeability, such as a ferrite.

The ferrite may be of varied form, notably in the shape of a U. In this case, the source coil and the coil of the sensitive element may each surround one of the lateral branches of the ferrite.

In this embodiment, the range of the sensor can be improved simply by increasing the spacing between the two ends of the U.

This range may also be increased by increasing the cross section of the poles formed by the two parallel bars of the U-shaped ferrite.

According to highly preferred embodiments, in the absence of an adjacent reinforcement the source of alternating magnetic field has no or weak coupling to the sensitive element.

As a result, when the source is powered and there is no adjacent reinforcement, it generates a zero or weak voltage in the sensitive element. That means that the common mode can be greatly or completely reduced.

Advantageously, the coils, of the source and of the sensitive element, are flat and crossed coils.

This embodiment has the advantage of simplifying the control electronics and associated measurement electronics and of reducing the costs thereof

What is meant by “flat coils” is coils the thickness of which is very much smaller than the other dimensions thereof.

The use of flat coils makes it possible to obtain a sensor that is very small in thickness, of the order of one or a few millimetres, thus achieving a complete system that can be laid on a roadway without the need to embed it therein. Since this complete system is only a few millimetres thick, vehicles can run over it without having to reduce their speed greatly.

What is meant by “crossed coils” is the fact that the intersection between the surface areas covered by each of the coils is non zero and less than the surface area of the smallest of the two coils. Thus, the common mode can be cancelled and the sensitive element coil does not pick up any signal in the absence of an adjacent reinforcement; what that means to say is that the voltage at the terminals of the coil of the sensitive element can be zero for a carefully selected setup with a partial superposition of the two coils in free conditions.

According to another embodiment, the sensor comprises at least one source coil and the sensitive element comprises one or more pairs of coils. The coils of each pair are positioned symmetrically relative to the source coil. The outputs of each of the coils of the sensitive element are connected to conditioning electronics and the subelements thus created are connected to one another in such a way that the output signal from the assembly is weak or zero in the absence of an adjacent reinforcement.

In this embodiment, the axes of sensitivity of the source coil, on the one hand, and of the coils of the sensitive element, on the other, are preferably parallel or perpendicular.

In a simplified embodiment, conditioning electronics can be dispensed with and a galvanic connection made between the coils of the sensitive element so that the output signal of the assembly is weak or zero in the absence of an adjacent reinforcement. Advantageously, with each coil having an axis of sensitivity, the axes of sensitivity of the coils of each sensitive element pair are coincident and the coils of the pairs are positioned one on each side of a plane of symmetry of the source coil.

According to one particular embodiment, the sensor comprises a material with high electrical resistivity and high magnetic permeability, such as a ferrite, which obeys the zero coupling between the source and the sensitive element in the absence of a reinforcement.

The presence of this material with high electrical resistivity and high magnetic permeability makes it possible to encourage coupling between the reinforcement and the sensor.

This material with high electrical resistivity and high magnetic permeability may, by way of example, be in the shape of an H.

For preference, the H is positioned in the casing with the lateral branches normal to the application face of the casing.

The source may then be a coil positioned around the central bar of the H.

The source may also comprise two coils each one positioned around one lateral branch of the H, preferably one on each side of the central bar of the H.

The source may also comprise four coils each one arranged around half a lateral branch of the H.

The sensitive element may comprise two coils positioned around one and the same lateral branch of the H, one on each side of the central branch.

It is also possible to position the two coils of the sensitive element each on a distinct lateral branch of the H but still one on each side of the central branch of the H.

It is also possible as sensitive element to use four coils, each one around half a lateral branch of the H.

According to another embodiment, the source is a coil of given diameter and the sensitive element is made up of two coils, the first coil of the sensitive element having a diameter smaller than the diameter of the source coil and the second coil of the sensitive element having a diameter greater than the diameter of the source coil, the three coils being concentric.

It should be noted that the diameter of a coil here means the outside diameter thereof.

In this embodiment, the two coils of the sensitive element may each be connected to conditioning electronics, and the two subassemblies thus obtained connected to one another so that when the source coil is supplied with a signal of non zero frequency, the output signal from the sensitive element assembly is weak or zero in the absence of an adjacent layer.

With a carefully selected setup for the diameter of the two coils of the sensitive element, it is also possible to achieve a direct galvanic connection between the two coils of the sensitive element so that the output signal from the assembly is weak or zero in the absence of an adjacent layer. That makes it possible to avoid the use of conditioning electronics for each sensitive element coil, but does require that the two coils of the sensitive element be wound in opposite directions from one another.

In this case, the electronic circuitry controlling the measurement system is simpler.

Advantageously, the coils of the source and of the sensitive element are flat coils.

In this embodiment, the distance between the sensor and an adjacent reinforcement may be evaluated from the output signal U at the terminals of the assembly consisting of the two coils of the sensitive element.

This axisymmetric embodiment has the advantage of being insensitive to the orientation of the metal cords forming the adjacent reinforcement. The sensor is therefore insensitive to the anisotropy of the adjacent layer.

In all the embodiments, the source and the sensitive element may each comprise one or more coils.

In all the embodiments, the range of the sensor can be improved simply by increasing the diameter of the source coil.

In the embodiments using ferrite, the range of the sensor may be improved simply by increasing the distance and/or the cross section of the poles formed by the ends of the ferrite.

The source coil is supplied by an alternating electric source, advantageously with a frequency lower than 500 kHz and this then very greatly limits the generation of eddy currents in the adjacent reinforcement of the layer. Additionally, if a frequency of 10 kHz is exceeded, the conventional noise measured by an antenna in the near field is avoided.

Furthermore, as the supply frequency increases for a given current, the time resolution of the measurement improves.

Additionally, increasing the frequency makes it possible to reduce the measurement time, which has a favourable effect on the power consumption of the whole system.

Finally, increasing the frequency makes it possible to increase the amplitude of the output signal of the sensitive element, whether this be made up of one coil or several.

It has been found to be advantageous to use a supply frequency in the range from 40 to 150 kHz.

These limits on the frequency make it possible to limit the eddy currents likely to arise in the metallic reinforcers of the tire reinforcement.

For preference, the measurement system comprises a device for measuring the amplitude of the signal at the terminals of the coil or coils of the sensitive element.

To do this, the source coil can be supplied with a known stationary sinusoidal current, making it possible repeatedly to fix the magnetic flux density emitted in the vicinity of the sensor, and a device for measuring the amplitude of the voltage at the terminals of the coil or coils constituting the sensitive element can be used.

This device for measuring the amplitude of the voltage at the terminals of the sensitive element may measure the voltage continuously or may use an amplitude demodulation system.

The measurement system is advantageously positioned in an electrically non-conductive casing whose materials have a magnetic susceptibility equal to zero or sufficiently low to be similar to those of air or a vacuum.

Preferably, with the source coil having an axis of sensitivity and the casing having a face for application against the free face of the layer whose thickness is to be measured, the application face of the casing is normal or parallel to the axis of sensitivity of the source coil according to the embodiment.

The casing may be a portable casing.

In this case, the measurement system according to one subject of the invention may be used for measuring the thickness of rubber material of a sidewall or of an inner liner of a tire. This measurement can be performed during the manufacture of the tire or after the completion of this operation.

The casing may also be suitable for positioning on, or embedding in, a roadway.

In this case, the measurement system is preferably used for measuring the thickness of remaining rubber material on a tire tread.

Evidently, each coil of the source or of the sensitive element of the measurement system according to one subject of the invention may be formed by a plurality of coils connected in series or in parallel.

For preference, when the coils used are flat coils, each of the coils of the source and of the sensitive element may be produced in the form of conducting tracks wound in spirals on a PCB or plastronic support.

A plastronic support refers to a technology that allows conducting tracks to be printed and electronic components to be fixed directly on injection moulding plastic components.

The invention is particularly applicable to tires having metal reinforcers in their crowns and/or their carcass plies, such as those intended to be fitted on vehicles of the passenger or SUV (“Sport Utility Vehicle”) type, or on industrial vehicles selected from among vans, heavy transport vehicles—i.e. light rail vehicles, buses, heavy road transport vehicles (lorries, tractors and trailers), and off-road vehicles such as civil engineering vehicles—, and other transport or handling vehicles.

### DESCRIPTION OF THE DRAWINGS

The attached figures show a number of embodiments of a measurement system according to one subject of the invention, taking as the principal example the application of the invention to the measurement of the thickness of tire treads:

FIG. 1 is a perspective view of a vehicle, a tire of which is passing over a casing comprising a measurement system according to one subject of the invention;

FIG. 2 shows a casing with a measurement system;

FIG. 3 shows a cross section of a tire in contact with the casing of the measurement system;

FIG. 4 schematically depicts the structure of a sensor made up of a source coil and of a single sensitive element coil;

FIG. 5 shows an example of measurements made with the sensor of FIG. 4;

FIG. 6 schematically depicts the structure of a sensor for which the three coils of which it is made are concentric;

FIG. 7 schematically depicts a sensor comprising an H-shaped ferrite;

FIGS. 8 and 9 depict alternative embodiments of the sensor of FIG. 7; and

FIG. 10 schematically depicts a structure of the electronic circuitry of a measurement system.

### DETAILED DESCRIPTION OF THE INVENTION

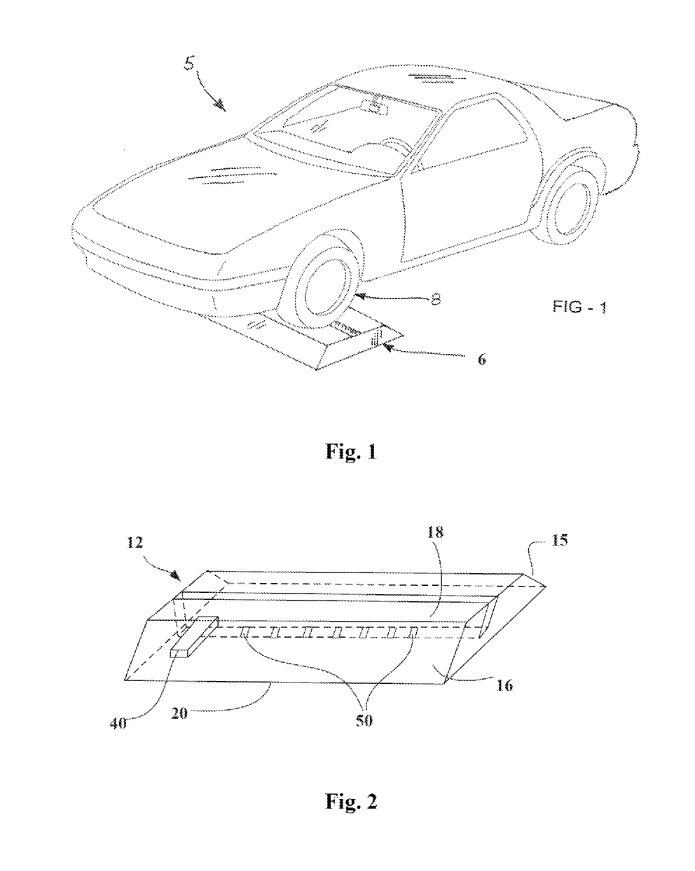

FIG. 1 shows a vehicle 5 whose tire 8 is running over a casing 6 comprising a wear measurement system. The drawing shows a passenger vehicle, but such a measurement system can also be used for any other vehicle, such as a heavy transport vehicle or a coach. The remaining thickness of rubber material on the tread of the tire 8 is measured when the tire runs over the casing 6, without any need to stop the vehicle or remove the tire from the vehicle.

FIG. 2 shows a casing 12 according to one of the subjects of the invention. This casing takes the form of a portable assembly which can be placed on a roadway. It has a substantially trapezoidal cross section. The casing comprises two inclined portions, namely an access ramp 15 and an exit ramp 16. Between these two portions there is a substantially horizontal portion 18. The portion 18 of the casing 12 protects a sensor or a row of sensors 50 for making the distance measurements. The base 20 of the casing is placed against the roadway and gives the casing the necessary stability during the operation of the system. The casing 12 also comprises electronic circuitry 40 with a power source which supplies the sensors 50 with alternating current. The measurements are made when the tire contact patch rests on the horizontal portion 18. This horizontal portion is the face of the casing which is applied to the surface of the tire tread. The casing 12 is made of a non-conductive material whose magnetic properties are similar to those of air, to avoid interference with the measurements.

According to other embodiments, the casing may be embedded in a roadway or may have suitable dimensions and weight for application against a sidewall or an inner liner of a tire.

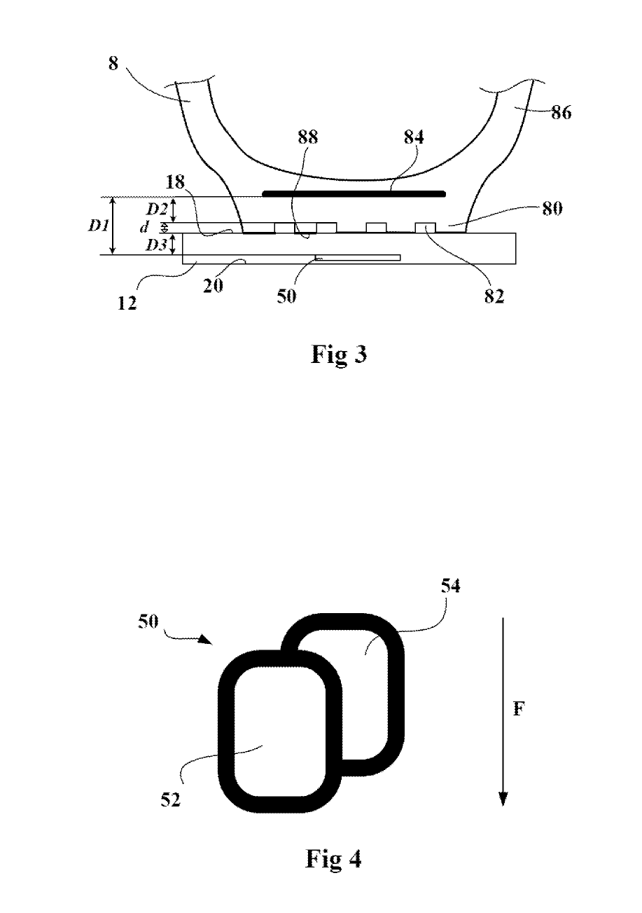

The measurement of the thickness of remaining rubber material on a tire tread is illustrated in FIG. 3. This drawing shows a partial cross section of a tire 8 bearing on the application face 18 of a casing 12. The tire 8 comprises, notably, a tread 80 with tread patterns 82, a crown reinforcement 84 consisting of two or more plies of metal reinforcers (not shown), and sidewalls 86. The casing 12 comprises an application face 18, a base 20 and a row of sensors 50. The running surface 88 of the tread 80 bears against the application face 18 of the casing 12.

The sensors 50 measure, as will be explained below, the distance D1 which separates them from the metal reinforcement 84 of the crown of the tire 8. D1 has three components. Two of these components are fixed, namely the distance D2 which separates the bases of the tread patterns 82 from the reinforcement 84, and the distance D3 which separates the sensors 50 from the application face 18 of the casing 12. One component is variable with the degree of wear of the tread, namely d, which corresponds to the remaining thickness of the tread. Thus:

d=D1−D2−D3

The distance D2 can be known on the basis of the identification of the type of tire being measured. This identification may be manual or automatic, being performed, for example, by retrieving identification data recorded in a transponder such as an RFID device incorporated in the tire structure.

FIGS. 4, 6, 7, 8 and 9 show alternative embodiments of sensors.

In FIG. 4, the sensor 50 comprises two crossed coils. The first is the source coil 52 and the second is the coil of the sensitive element 54. The two coils shown are flat coils of substantially rectangular shape, but coils of circular shape are also entirely usable. The two flat coils are substantially in one and the same plane parallel to the plane of application of the tread of a tire. The arrow F indicates the intended direction of running.

In this embodiment, the intersection between the surface areas covered by each of the coils is non zero and less than the surface area of the smallest of the two coils. In this way, the common mode can be cancelled and the coil of the sensitive element 54 picks up little or no signal in the absence of an adjacent reinforcement; what that means to say is that the voltage at the terminals of the coil of the sensitive element 54 may be weak or zero for a carefully selected setup with a partial superimposition of the two coils under free conditions.

Tests with this sensor configuration were carried out.

A section of radial tire for a heavy transport vehicle was used for these tests, after the rubber of the tread had been planed down. The zero for the measurements was determined under free conditions, namely with the cross section distant from the sensor.

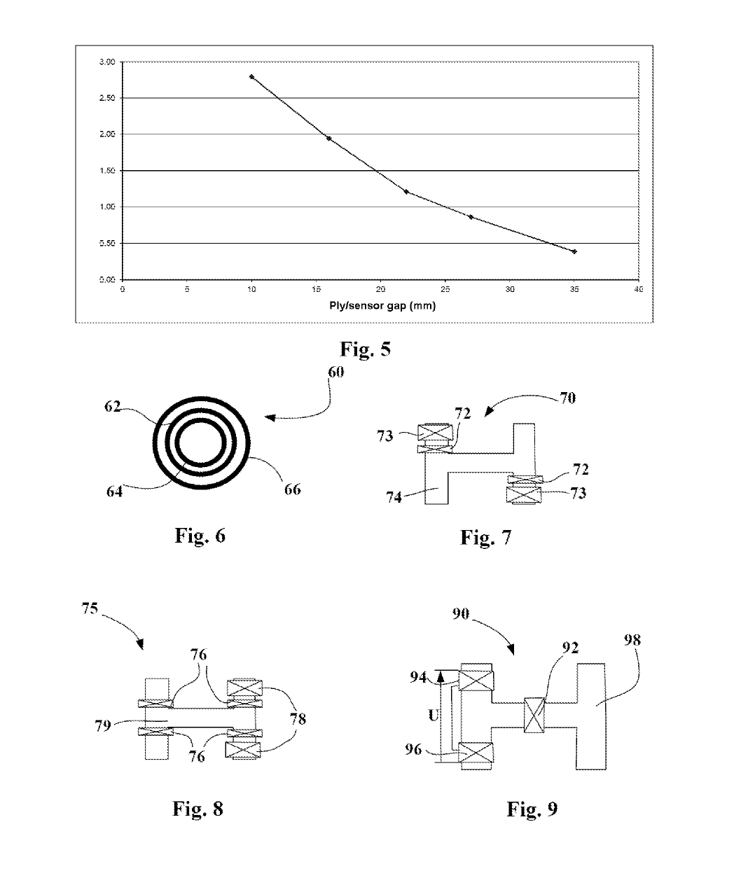

After that, the cross section was brought progressively closer to the sensor. The results are shown in FIG. 5. The abscissa axis shows the distance of the gap between the metal reinforcers of the crown reinforcement of the section and the plane of the two coils of the sensor, and the ordinate axis represents the maximum amplitude of the voltage measured at the terminals of the coil of the sensitive element of the sensor.

The source coil was supplied at a frequency of 40 kHz.

A very appreciable reduction in the voltage at the terminals of the coil of the sensitive element was observed from a gap of the order of 10 mm to around 30 mm.

This demonstrates that the mode of operation of the sensor according to one of the subjects of the invention is indeed a reluctance mode which is therefore associated with the magnetic permeability of the various parts of the magnetic circuit made up of the source and the crown reinforcement of the section of which the distance is being measured using the sensor.

In FIG. 6, the sensor 60 comprises a source coil 62 and two coils 64 and 66 of the sensitive element.

The coil 64 of the sensitive element has a diameter smaller than the diameter of the source coil 62.

The coil 66 of the sensitive element has a diameter greater than the diameter of the source coil 62.

The three coils are concentric so that the sensor produced is axisymetric. Such a configuration makes it possible to obtain a ply effect that is very weak in comparison with other embodiments.

In this embodiment, the two coils 64 and 66 of the sensitive element are galvanically connected so that the direction of winding of the coil 64 is the opposite of the direction of winding of the coil 66.

In this particular configuration, with the amplitude of the output signals from the two coils of the sensitive element being denoted U1 and U2 respectively, the distance between the sensor and an adjacent reinforcement may be evaluated from the output signal

U at the terminals of the assembly consisting of the two coils of the sensitive element, such that:

U=U1+U2

When the source coil is supplied with a signal of non zero frequency and for a carefully selected setup of the diameter of the two coils of the sensitive element, the signal U may be weak or zero in the absence of an adjacent reinforcement.

This axisymetric embodiment has the advantage of being insensitive to the orientation of the metal cords forming the adjacent reinforcement. The sensor is therefore insensitive to the anisotropy of this adjacent layer.

FIG. 9 shows another embodiment of a sensor 90. This sensor 90 comprises a ferrite 98 in the shape of an H with a source coil 92 positioned around the central branch of the H. The sensor also comprises two coils 94 and 96 of the sensitive element each of which is positioned around one and the same lateral branch of the H. The two coils 94 and 96 are arranged symmetrically relative to the source coil, in this instance one on each side of a plane of symmetry of the source coil or even one on each side of the central bar of the H.

These two coils 94, 96 may be galvanically connected in series with their windings reversed. That makes it possible to obtain a configuration for which the output signal of the assembly consisting of the two coils of the sensitive element is weak or zero in the absence of an adjacent layer, and this makes it possible to simplify the electronic circuitry needed at the output of the sensor.

In this embodiment it is possible to evaluate the distance between the sensor and an adjacent reinforcement from the amplitude of the output signal U at the terminals of the assembly consisting of the two coils 94 and 96 of the sensitive element.

FIG. 7 shows a sensor 70 similar to that of FIG. 9, in which sensor the source consists of two excitation coils 72 each one positioned around a lateral bar of the H, one on each side of the central bar, and the sensitive element of two coils 73 each of which is arranged around a lateral bar of the H, one on each side of the central bar of the H.

FIG. 8 shows a sensor 75 comprising an H-shaped ferrite 79, a magnetic field source made up of four excitation coils 76 each one positioned around half a lateral branch of the H and a sensitive element comprising two coils 78. The two coils 78 are each positioned around a lateral branch of the H, one on each side of the central branch.

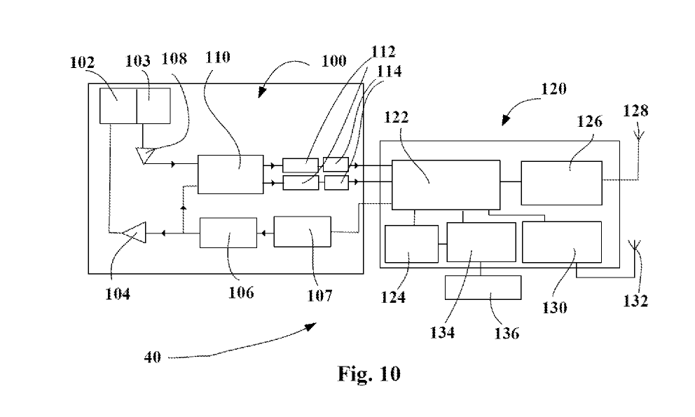

FIG. 10 shows one example of the structure of the electronic circuitry that allows the measurement of the thickness of a layer of tire rubber, in the case of a sensor consisting of a source coil 102 and of a sensitive element 103 consisting of a single coil, or of several coils connected to one another.

This electronic circuitry is formed by a “sensor module” 100 and a “motherboard” 120. It can therefore be used to measure the thickness of a layer at a single point.

In order to extend the principle of this arrangement to a system consisting of multiple sensors, it is simply necessary to use a plurality of “sensor modules”, all connected to the same “motherboard”.

In reluctance mode, the voltage U at the terminals of the sensitive element 103 increases as the distance d between the sensor and a reinforcement of an adjacent layer, made up of metal tire chords, decreases. The purpose of this electronic circuitry is therefore to measure the magnitude of this voltage U, in order to be able to deduce this distance between the sensor and the reinforcement of the adjacent layer.

Aside from the source coil 102 and the sensitive element 103, the “sensor module” 100 is made up, amongst other things, of a current amplifier 104, driven by an oscillator 106 of which the frequency is imposed by a time base 107. The amplifier, oscillator and time base form part of the “sensor module”. The current generated by the amplifier 104 injected into the source coil 102 is considered as the phase reference (φ=0).

The voltage U for the phase φ, which is non-zero relative to the current I, collected at the terminals of the sensitive element 103, is first amplified by the amplifier 108 and then injected into a double demodulator 110, together with the output signal of the oscillator 106.

At the output of the demodulator 110, the signals X and Y are found, representing the two complex components describing the voltage at the terminals of the sensitive element, such that:

U=K√X²+Y²

where K is a factor dependent on the amplification present along the electronic circuit.

The two signals X and Y are then filtered by the filters 112 and digitized by means of analogue/digital converters (ADC) 114, and are then injected into the microcontroller 122 of the “motherboard” 120.

From X and Y the microcontroller 122 deduces the magnitude of the voltage U at the terminals of the sensitive element 103, by using the formula above.

The motherboard is also provided with a number of additional functional units, namely:
a memory 124 to allow the measurements taken by the sensor consisting of the source coil 102 and of the sensitive element 103 to be recorded;
an RFID decoder 126 for identifying the tire, by means of an antenna 128, if this can be done by using the presence of an RFID device incorporated in the tire structure;
a wireless communication module 130 for sending data over a distance, via a supplementary antenna 132; and
a power supply 134 distributing the current required for the whole system from a battery 136.

The assembly is able to perform numerous measurements on tires without a battery change, giving the system several years of service life without human intervention.

1-30. (canceled)

31. A measurement system for measuring a thickness of a layer of rubber material of a tire, the layer including a joined face, which is joined to an adjacent reinforcement made with at least one material having a magnetic permeability greater than a magnetic permeability of air, and a free face, which is in contact with air, the system comprising:
a casing structured to include an application face for contacting the free face of the layer; and
a sensor positioned in the casing and arranged to measure a distance d between the joined face and the free face of the layer, the sensor including:
a source coil element, which is a source of an alternating magnetic field, and
a sensitive coil element, which is an element sensitive to a variation in a magnetic flux density in a vicinity of the source coil element,
wherein a frequency and an excitation power of the source coil element are such that the magnetic flux density between the adjacent reinforcement and the source coil element increases as the distance d decreases.

31. The measurement system according to claim 31, wherein the sensitive coil element is positioned between the source coil element and the application face of the casing.

31. The measurement system according to claim 31, wherein the source coil element is positioned between the sensitive coil element and the application face of the casing.

31. The measurement system according to claim 31, wherein the sensitive coil element and the source coil element are positioned without overlap so that the sensitive coil element and the source coil element are adjacent and substantially a same distance from the application face of the casing.

31. The measurement system according to claim 31, wherein the source coil element and the sensitive coil element surround, or are surrounded by, a material with high electrical resistivity and high magnetic permeability.

31. The measurement system according to claim 31, wherein, when the adjacent reinforcement is absent, the source coil element has no coupling or a weak coupling to the sensitive coil element.

36. The measurement system according to claim 36, wherein the source coil element and the sensitive coil element are flat and crossed.

36. The measurement system according to claim 36, wherein the source coil element and the sensitive coil element surround, or are surrounded by, a material with high electrical resistivity and high magnetic permeability.

38. The measurement system according to claim 38, wherein the material having high electrical resistivity and high magnetic permeability is an H-shaped material.

39. The measurement system according to claim 39, wherein the H-shaped material is positioned in the casing such that lateral branches are arranged normal to the application face of the casing.

39. The measurement system according to claim 39, where the source coil element is an excitation coil positioned around a central bar of the H-shaped material.

39. The measurement system according to claim 39, wherein the source coil element includes two excitation coils, each excitation coil being positioned around a lateral branch of the H-shaped material, respectively, with a position on each side of a central branch of the H-shaped material being preferable.

39. The measurement system according to claim 39, wherein the source coil element includes four excitation coils, each excitation coil being positioned around half a lateral branch of the H-shaped material, respectively.

39. The measurement system according to claim 39, wherein the sensitive coil element includes two coils positioned around a same lateral branch of the H-shaped material, one on each side of a central branch of the H-shaped material.

39. The measurement system according to claim 39, wherein the sensitive coil element includes two coils, each of the two coils being positioned on a distinct lateral branch of the H-shaped material, respectively, with one coil being positioned on each side of a central branch of the H-shaped material.

39. The measurement system according to claim 39, wherein the sensitive coil element includes four coils, each of the four coils being arranged on half a lateral branch of the H-shaped material, respectively.

36. The measurement system according to claim 36, wherein:
the source coil element has a given diameter, and
the sensitive coil element includes two coils, a diameter of a first of the two coils being greater than the given diameter of the source coil element, and a diameter of a second of the two coils being less than the diameter of the source coil element, and
the source coil element and the two coils of the sensitive coil element are concentric.

47. The measurement system according to claim 47, wherein the source coil element and the sensitive coil element are flat coils.

31. The measurement system according to claim 31, wherein the source coil element includes one or more coils.

31. The measurement system according to claim 31, wherein the sensitive coil element includes one or more coils.

31. The measurement system according to claim 31, wherein the source coil element is supplied with an alternating voltage or an alternating current having a frequency below 500 kHz.

51. The measurement system according to claim 51, wherein the alternating voltage or the alternating current supplied to the source coil element has a frequency higher than 10 kHz.

51. The measurement system according to claim 51, wherein the alternating voltage or the alternating current supplied to the source coil element has a frequency between 40 kHz and 150 kHz.

31. The measurement system according to claim 31, further comprising a measurement device for measuring an amplitude of a signal at terminals of the sensitive coil element.

48. The measurement system according to claim 48, wherein each of the flat coils is produced in a form of conducting tracks wound in a substantially spiral shape on a PCB or a plastronic support.

31. The measurement system according to claim 31, wherein the casing is not electrically conductive and has magnetic properties similar to those of air, and the application face of the casing is parallel or normal to a direction of an axis of sensitivity of the source coil element.

56. The measurement system according to claim 56, wherein the casing is a portable casing.

58. The measurement system according to claim 56, wherein the casing is structured to be positioned on or embeddable in a roadway.

59. A method for measuring a thickness of a remaining layer of rubber material on a tread of a tire, the layer including a joined face, which is joined to an adjacent reinforcement made with at least one material having a magnetic permeability greater than a magnetic permeability of air, and a free face, which is in contact with air, the method comprising utilizing a system that includes:
a casing structured to include an application face for contacting the free face of the layer, and
a sensor positioned in the casing and arranged to measure a distance d between the joined face and the free face of the layer, the sensor including:
a source coil element, which is a source of an alternating magnetic field, and
a sensitive coil element, which is an element sensitive to a variation in a magnetic flux density in a vicinity of the source coil element,
wherein a frequency and an excitation power of the source coil element are such that the magnetic flux density between the adjacent reinforcement and the source coil element increases as the distance d decreases.

60. A method for measuring a thickness of a layer of rubber material of a sidewall or an internal liner of a tire, the layer including a joined face, which is joined to an adjacent reinforcement made with at least one material having a magnetic permeability greater than a magnetic permeability of air, and a free face, which is in contact with air, the method comprising utilizing a system that includes:
a casing structured to include an application face for contacting the free face of the layer, and
a sensor positioned in the casing and arranged to measure a distance d between the joined face and the free face of the layer, the sensor including:
a source coil element, which is a source of an alternating magnetic field, and
a sensitive coil element, which is an element sensitive to a variation in a magnetic flux density in a vicinity of the source coil element,
wherein a frequency and an excitation power of the source coil element are such that the magnetic flux density between the adjacent reinforcement and the source coil element increases as the distance d decreases.
